(19) United States
(12) Patent Application Publication
(10) Pub. No.: US 2011/0272432 A1
(43) Pub. Date: Nov. 10, 2011

(54) FOAM DISPENSER

(76) Inventor: Gary M. Baughman, Fremont, IN (US)

(21) Appl. No.: 12/776,665

(22) Filed: May 10, 2010

(51) Int. Cl. B67D 7/74; B67D 7/60

(52) U.S. Cl. 222/136; 222/145.5; 222/190

(57) ABSTRACT

A foam dispenser for dispensing a liquid with a foam consistency includes a container which is constructed and arranged to hold a volume of liquid and a pump assembly which is connected to the container. The pump assembly includes an actuator defining a foam-dispensing outlet, a collar constructed and arranged to connect to a portion of the container, the collar receiving the actuator, a body defining an air chamber and a liquid chamber, a foamer housing received by the actuator and including a mesh screen, an air piston received by the air chamber, a plunger extending through a portion of the air chamber into the liquid chamber, a movable valve pin received by the plunger, an air valve received by the piston and being constructed and arranged to control the flow of replacement air into the air chamber, and a liquid flow control structure received by the body and cooperating with the volume of liquid for controlling the flow of replacement liquid into the liquid chamber.

### BACKGROUND OF THE INVENTION

Foam dispensers which are currently offered for dispensing a liquid substance with a foam consistency (due to the mixing of air) are typically configured for manual operation. A pump assembly is attached to the neck opening of a liquid reservoir (container) and cooperating air and liquid pumps are used to introduce air and liquid into a mixing chamber or area. Manually depressing an actuator causes an air piston and a liquid piston or plunger to move (usually simultaneously or nearly so) in such a way that liquid is pumped or drawn from a liquid chamber and air is drawn from an air chamber in order to produce a foam by blending these two constituents together and forcing the combination of liquid and air through a mesh screen or other similar structure in order to produce air bubbles.

One of the considerations when designing foam dispensers of the type generally described above is the suitability of the mechanical construction for a variety of liquids. The referenced “variety” includes various chemical compositions as well as various viscosities for these chemical compositions. Another consideration is the quality of foam which is capable of being produced by the mechanical construction, the manner or method of use, and the chemical composition of the liquid. A related structural feature in terms of the quality of foam includes the number, location, and style of mesh screens which are used as part of the foam production process. The production of foam involves a blending of air and the selected liquid and essentially forcing the air through a body, stream, or sheet of liquid so as to create small air bubbles. These small air bubbles are coated with a thin film of the liquid and the surface tension of the liquid tends to maintain its coated status around the small air bubbles.

Another factor which can influence the quality of foam which can be produced by the dispenser is the speed of movement of the air piston and liquid piston or plunger. Acceleration of the two pistons up to the desired speed and maintaining that desired speed contributes to defining the quality of the foam being produced. The speed of the pistons influences the speed of the flow of air and the flow of liquid through their respective passageways to the point of initial mixing. The size of the passageways or other flow openings also has an effect on the speed of the air and liquid flows. It is though not always possible to fully inform the user of the foam dispenser of these factors with only the normal printed instructions which would typically accompany the foam dispenser. The user may not understand that speed is a factor which can influence the quality of the foam which is produced and dispensed. A still further factor which needs to be assessed in the design and construction of a foam dispenser is the overall dispenser complexity. Reduced complexity of the foam dispenser can be a contributing factor to a more reliable foam dispenser. Even if reliability is not significantly improved, reduced complexity usually means a reduced cost.

The foam dispenser structure disclosed herein, i.e., the selected embodiment, is considered to have reduced complexity and it is expected that there will be a corresponding reduced cost as compared to many prior art constructions. The selected embodiment is considered to have improved reliability relative to many prior art constructions due to its simplified construction. The reduced complexity results from simpler air flow arrangements and the elimination of any type of gadget or specialized features. Often these gadgets or specialized features simply add complexity and cost and are not always directed to the ultimate objective of producing quality foam from a variety of liquids.

The selected embodiment is designed with actuator interference with respect to the receiving collar causing an increase in the level of force required to initiate downward axial movement of the actuator. Once the interference is cleared, the level of force being applied creates an acceleration of the actuator. The actuator controls the downward axial movement of the air piston and of the liquid piston or plunger and thus the acceleration of these components is also influenced by the movement or travel of the actuator. Having this acceleration means that the desired speed is achieved sooner and the quality of the foam is improved.

The selected embodiment provides a foam dispenser with less complexity than various prior art structures by enabling a premix of the air and liquid before passing through a first mesh screen which is a part of the foamer housing. This premixing, which is similar to having an extra mesh screen at this location, achieves much the same result without the added cost and without the added complexity of requiring a third mesh screen. Another design simplification offered by the selected embodiment disclosed herein is the use of a liquid flow valve structure to help control the valving of the air flow into the premix location before entry through the first mesh screen.

### BRIEF SUMMARY

A foam dispenser for dispensing a liquid with a foam consistency includes a container which is constructed and arranged to hold a volume of liquid and a pump assembly which is connected to the container. The pump assembly includes an actuator defining a foam-dispensing outlet, a collar constructed and arranged to connect to a portion of the container, the collar receiving the actuator, a body defining an air chamber and a liquid chamber, a foamer housing received by the actuator and including a mesh screen, an air piston received by the air chamber, a plunger extending through a portion of the air chamber into the liquid chamber, a movable valve pin received by the plunger, an air valve received by the piston and being constructed and arranged to control the flow of replacement air into the air chamber, and a liquid flow control structure received by the body and cooperating with the volume of liquid for controlling the flow of replacement liquid into the liquid chamber.

One feature of the selected embodiment is the presence of an interference fit between the collar and the actuator so as to require a higher force initially which results in actuator acceleration.

Another feature of the selected embodiment is using the valve pin to open both a liquid passageway and an air passageway wherein movement of the valve pin is achieved by the use of liquid flow.

### BRIEF DESCRIPTION OF THE SEVERAL VIEWS OF THE DRAWINGS

FIG. 1 is a side elevation view, in full section, of a foam dispenser according to the selected embodiment.

FIG. 2 is a side elevation view of the FIG. 1 dispenser without the container and overcap.

FIG. 3A is a side elevational view, in full section, of a collar which comprises one part of the FIG. 1 foam dispenser.

FIG. 3B is a top plan view of the FIG. 3A collar.

FIG. 3C is a bottom plan view of the FIG. 3A collar.

FIG. 4A is a side elevational view, in full section, of a body which comprises one part of the FIG. 1 foam dispenser.

FIG. 4B is a bottom perspective view of the FIG. 4A body.

FIG. 4C is a bottom plan view of the FIG. 4A body.

FIG. 5 is a side elevational view, in full section, of a gasket which comprises one part of the FIG. 1 foam dispenser.

FIG. 6A is a side elevational view, in full section, of a actuator which comprises one part of the FIG. 1 foam dispenser.

FIG. 6B is a front elevational view of the FIG. 6A actuator.

FIG. 6C is a top plan view of the FIG. 6A actuator.

FIG. 6D is a bottom plan view of the FIG. 6A actuator.

FIG. 7A is a side elevational view, in full section, of a piston which comprises one part of the FIG. 1 foam dispenser.

FIG. 7B is a top plan view of the FIG. 7A piston.

FIG. 7C is a bottom plan view of the FIG. 7A piston.

FIG. 7D is a partial, side elevational detail, in full section, of a detent portion of the FIG. 7A piston.

FIG. 8A is a side elevational view, in full section, of a foamer housing which comprises one part of the FIG. 1 foam dispenser.

FIG. 8B is a top plan of the FIG. 8A foamer housing.

FIG. 8C is a bottom plan view of the FIG. 8A foamer housing.

FIG. 9A is a side elevational view, in full section, of an one-way valve which comprises one part of the FIG. 1 foam dispenser.

FIG. 9B is a top plan view of the FIG. 9A one-way valve.

FIG. 10A is a side elevational view, in full section, of a plunger which comprises one part of the FIG. 1 foam dispenser.

FIG. 10B is a front elevational view of the FIG. 10A plunger.

FIG. 10C is a top plan view of the FIG. 10A plunger.

FIG. 10D is a bottom plan view of the FIG. 10A plunger.

FIG. 11A is a side elevational view, in full section, of a valve pin which comprises one part of the FIG. 1 foam dispenser.

FIG. 11B is a top plan view of the FIG. 11A valve pin.

FIG. 12A is a side elevational view, in full section, of a spring clip which comprises one part of the FIG. 1 foam dispenser.

FIG. 12B is a top plan view of the FIG. 12A spring clip.

FIG. 12C is a bottom plan view of the FIG. 12A spring clip.

FIG. 13 is a side elevational view, in full section, of the FIG. 1 foam dispenser in a half stroke position.

FIG. 14A is a partial, enlarged, side elevational view of the FIG. 1 foam dispenser with the valve pin in a seated position.

FIG. 14B is a partial, enlarged, side elevational view of the FIG. 1 foam dispenser with the valve pin in a raised position, permitting both liquid flow and air flow into a mixing location.

### DETAILED DESCRIPTION OF THE SELECTED EMBODIMENT

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

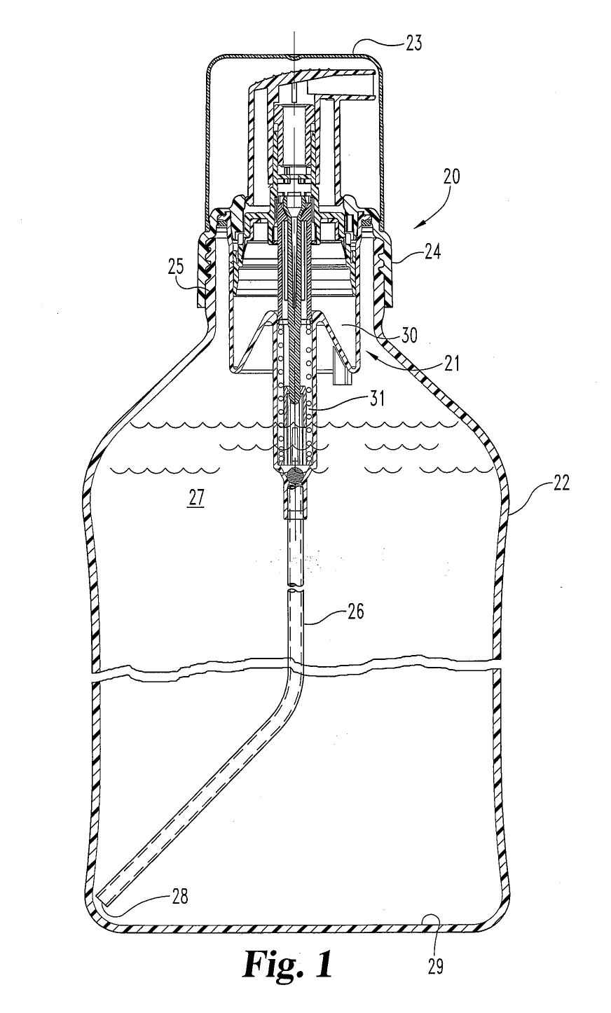

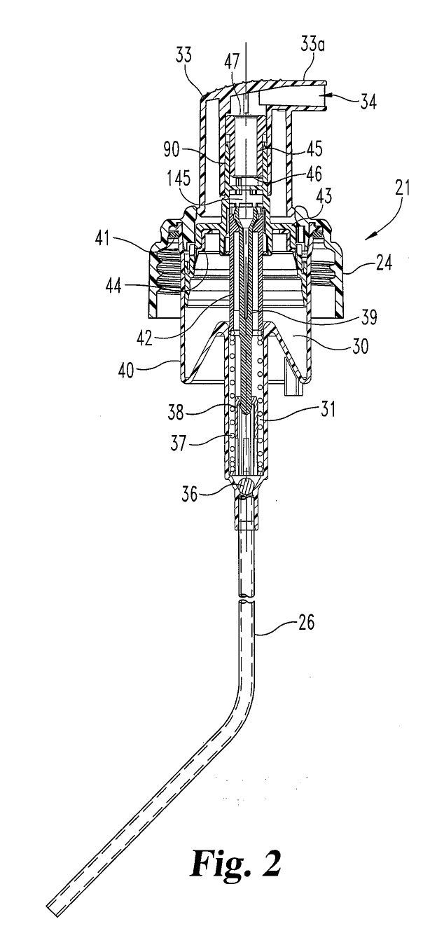

Referring to FIGS. 1 and 2, there is illustrated a foam dispenser 20 which includes a pump assembly 21, a liquid container 22, and protective overcap 23. The pump assembly 21 is securely assembled to the container 22 by the use of collar 24. The neck 25 of container 22 is externally threaded and the body of the collar 24 is internally threaded in a cooperating manner for threaded engagement onto the neck 25. The pump assembly includes an air chamber 30 and a liquid chamber 31. A portion of the pump assembly 21 is inserted into the interior of liquid container 22, allowing the dip tube 26 to extend into the liquid contents 27 of container 22. The length of dip tube 26 relative to the size and shape of container 22 is selected in order to position the open end 28 of the dip tube 26 near the bottom surface 29 of the liquid container 22. The dip tube 26 is fabricated out of a flexible material, preferably HDPE. At some location along its length the dip tube 26 may be bent so as to angle and direct the open end 28 into a “corner” of liquid container 22.

In view of the secure mechanical connection between the collar 24 and the remainder of the pump assembly 21, the threaded assembly of collar 24 onto neck 25 assembles the pump assembly 21 to and into the container 22. In the FIG. 2 illustration, the overcap 23 has been removed and the pump assembly 21 has been removed from the container 22. The overcap 23 is preferably a molded plastic component with a snap-fit assembly over an annular lip disposed on an outer surface portion of the collar 24. When the overcap 23 is snapped into position, it prevents access to the actuator (nozzle) 33 and thus prevents (manual) axial movement of the actuator 33. The overcap 23 also protects the pump assembly 21 from unintended actuation as well as from moisture and debris. When the overcap is removed from the collar 24 by manually snapping the overcap off of the collar, the actuator 33 is accessible for actuation by manually depressing the actuator in a downward direction. This type of actuation would typically be performed by the user of the foam to be dispensed from the actuator, though another person could dispense the foam for the ultimate user. Axially pushing down on the actuator 33 by an individual results in the production and dispensing of foam as will be described in greater detail hereinafter.

As used herein, the terms “up”, “top”, “down”, and “bottom” each have their normal or conventional meanings based on the foam dispenser 20 being set or positioned upright with the bottom surface of the container 22 being placed on a substantially horizontal surface. While this does not preclude the user or someone on behalf of the user picking up the foam dispenser and changing its orientation as foam is being dispensed, it is felt that the more common or likely use will be in the described vertical orientation on a substantially horizontal surface. Accordingly, this orientation is what has been used to define the terms mentioned above. This is also the orientation used for all of the drawings.

The actuator 33 might also be referred to as a nozzle or dispensing nozzle since this single piece component part of the pump assembly 21 is the component part used both as an actuator to initiate the production and delivery of foam and as the means for actually dispensing the foam through an outlet opening. As the foam is produced, it travels through the nozzle portion 33a and then out through dispensing opening 34. Nozzle portion 33a defines the shape and size of the dispensing opening 34. Hereafter, this component part will simply be referred to as actuator 33.

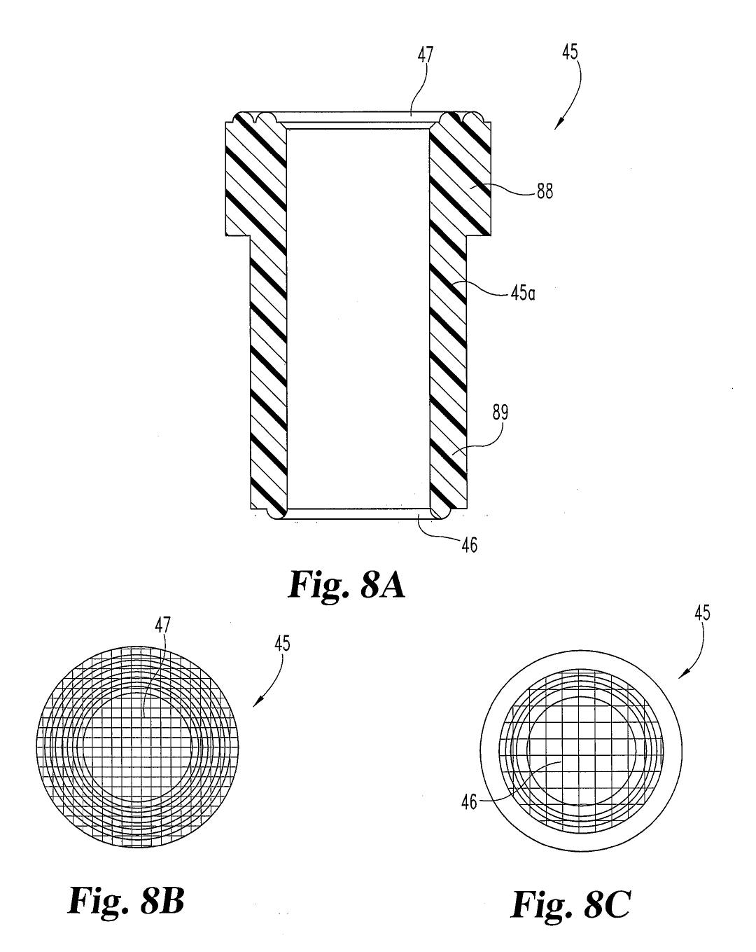

With continued reference to FIG. 2, the pump assembly 21 includes, in addition to actuator 33, collar 24 and dip tube 26, a ball (valve) 36, spring 37, spring clip 38, valve pin 39, body 40, gasket 41, plunger 42, piston 43, one-way valve 44, and a foamer housing 45 having a pair of mesh screens 46 and 47. Since the two mesh screens 46 and 47 are welded to the housing body 45a, one at each end (see FIG. 8A), reference to housing 45 is intended to include all three components as an integral unit.

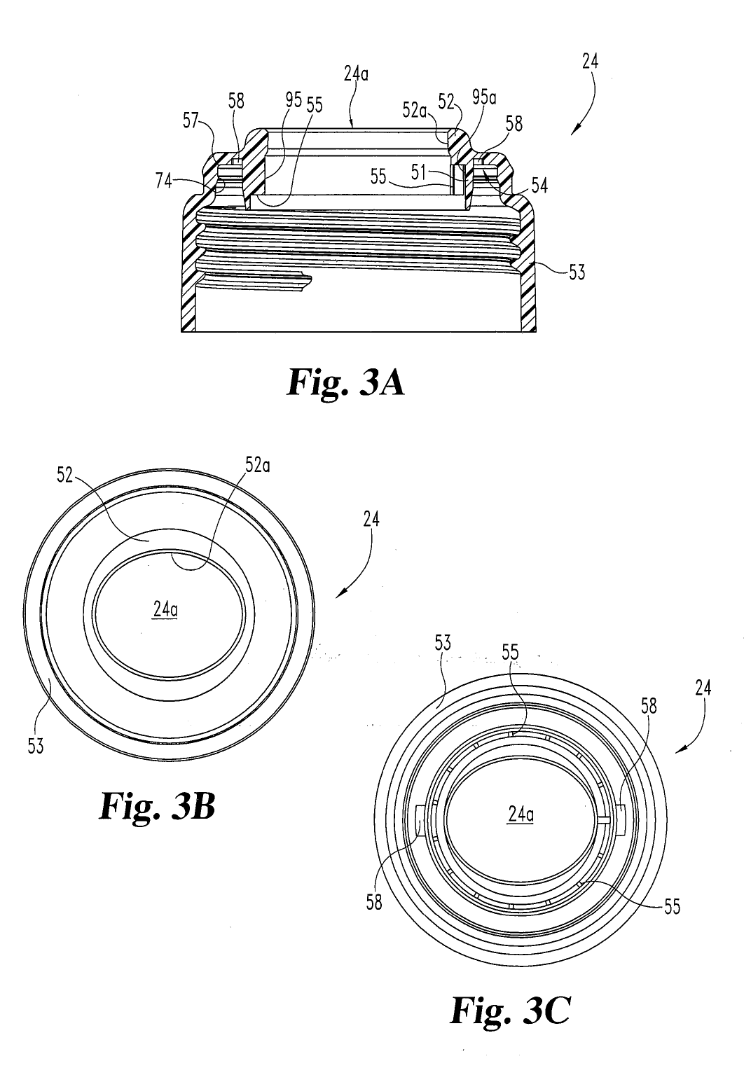

The annular collar 24 is further illustrated in FIGS. 3A-3C and is a single piece component having an inner wall 51, a raised actuator lip 52, an internally-threaded outer wall 53, and a downwardly-opening channel 54 positioned between the inner and outer walls 51 and 53, respectively. The raised actuator lip 52 defines interior opening 24a which receives other portions of the pump assembly 21, including the actuator 33. The uppermost portion of opening 24a which is directly adjacent to the raised actuator lip 52 preferably has an oval or elliptical shape which is constructed and arranged to closely match the oval or elliptical shape of the body of the actuator 33. As a design alternative, these matching elliptical shapes could be circular (i.e., cylindrical). The inner wall 51 defines a plurality of small abutment projections 55 which are constructed and arranged for axial alignment over portion 56 of the piston 43. In the selected embodiment, there are fifteen (15) abutment projections 55 and these prevent the piston 43 from traveling too far in an axially upward direction. The channel 54 includes an annular first portion 57 and a pair of radially offset and axially deeper alignment portions 58. These two alignment portions 58 are approximately 180 degrees apart and are helpful to the assembly process due to the oval or elliptical shapes which are present. Each alignment portion 58 is relatively small or narrow in circumferential “length” and receives a corresponding and comparably sized and shaped alignment projection 59 which is part of the body 40. The preferred material for collar 24 is polypropylene.

With regard to some of the terminology being utilized in the description of the selected embodiment, the preferred shape of the outer wall 82 of the actuator 33 and the preferred shape of the opening defined by the raised actuator lip 52 of the collar 24 have been described as oval or elliptical. Since the term “oval” would typically denote a continuous annular form which is not necessarily circular, that provides one option for the selected embodiment. However, an elliptical shape has a more precise geometric definition and is symmetrical with regard to the major and minor axes. Accordingly, the selected embodiment is elliptical in shape as to these components and that is the term to be used hereinafter. The elliptical shape also means that the actuator will install into the collar in one of only two orientations which are 180 degrees apart. In order to have these two assembly options available, and in order to position the open end 28 in a corner of the container, the two alignment portions 58 must be 180 degrees apart. It is to be understood that an oval shape for the actuator body and for the receiving opening would also be acceptable and consistent with the remaining structures disclosed herein by making the necessary modifications to the alignment features. As noted, one alternative construction is to change these elliptical shapes to circular (i.e., cylindrical). Additionally, terms such as “inner”, “outer”, and “intermediate” are defined for use herein as being based on the vertical axis of the foam dispenser as the center or innermost location. These terms reflect the relative positions of structural features relative to each other and relative to their location radially from that centered or central vertical axis.

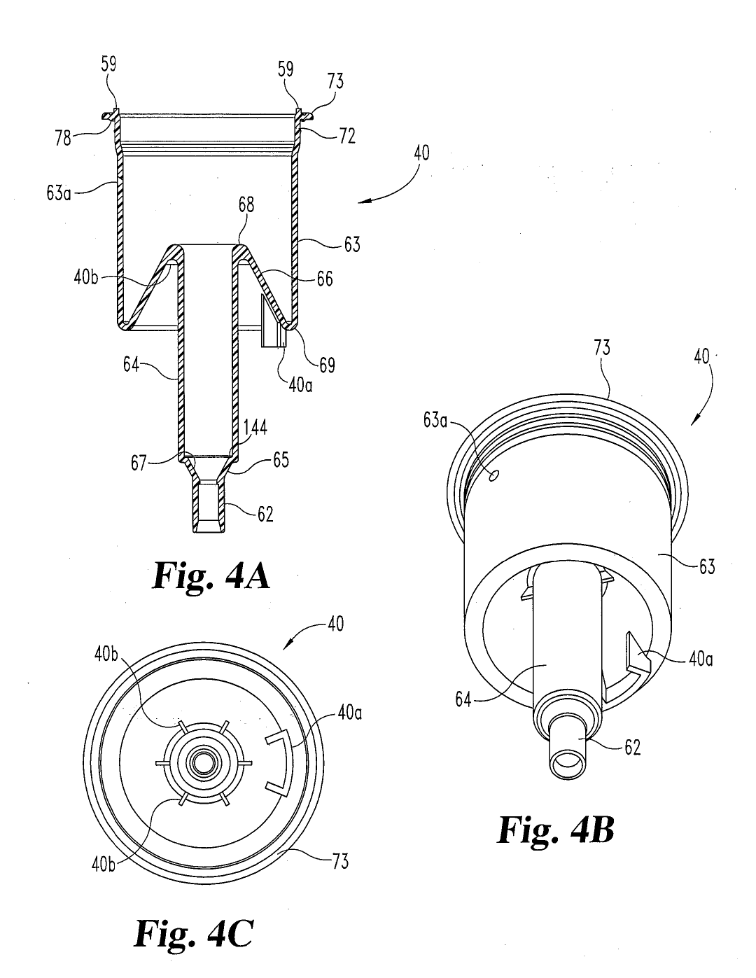

The annular body 40 is further illustrated in FIGS. 4A-4C and is a single piece component having an annular inner wall 62, an annular outer wall 63, an annular intermediate wall 64, and a pair of frustoconical transition sections 65 and 66. Section 65 connects the inner wall 62 with the intermediate wall 64 and the inner frustoconical surface 67 provides a valve seat for ball 36. Section 66 connects the outer wall 63 with the intermediate wall 64 and includes and is bounded by bends 68 and 69. Axially extending in a downward direction from a location adjacent bend 69 is alignment projection 40a. Projection 40a is sized and shaped to fit within a receiving pocket or recess in the automated assembly equipment (not illustrated) used for foam dispenser 20.

The upper end 72 of outer wall 63 is formed with a flange 73 which includes the two alignment projections 59. Assuming proper alignment of the projections 59 into or with the two alignment portions 58, flange 73 is constructed and arranged to snap into channel 54. In addition to having compatible sizes and shapes, radially inward rib 74 of collar 24 provides the reduced clearance for the snap-fit assembly. The outer wall 63 defines therein an air vent hole 63a. The six (6) gussets 40b are optionally molded on the concave side of bend 68 for reinforcement of wall 64 and overall stabilizing.

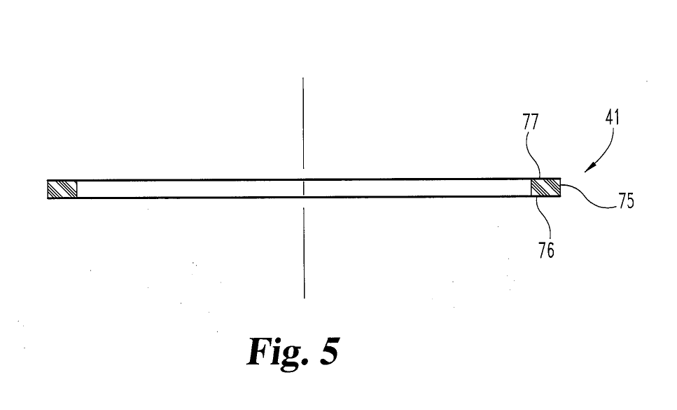

The gasket 41 is further illustrated in FIG. 5. Gasket 41 is an annular, square cut single piece component which is preferably fabricated out of a lamination of a foam layer 75 on the interior enclosed by LDPE layers 76 and 77 applied on the opposite faces of the foam layer 75. The circumferential outer surface of the foam layer remains exposed. The downwardly tapered projection 78 of flange 73 is in contact with the upwardly facing layer 77 of gasket 41.

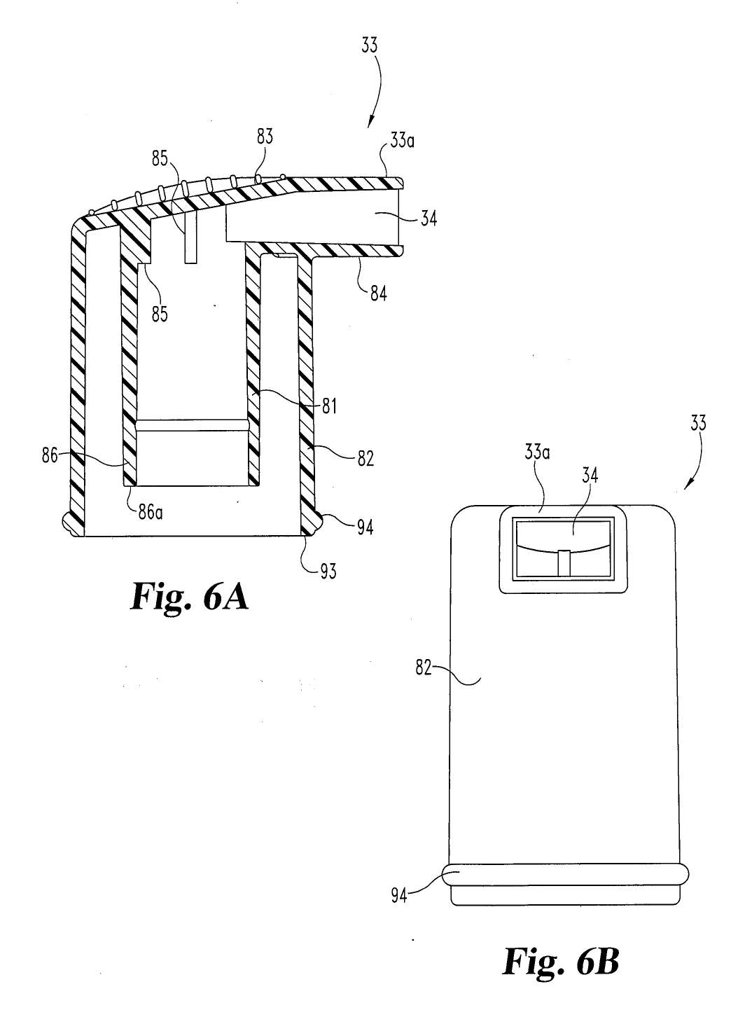

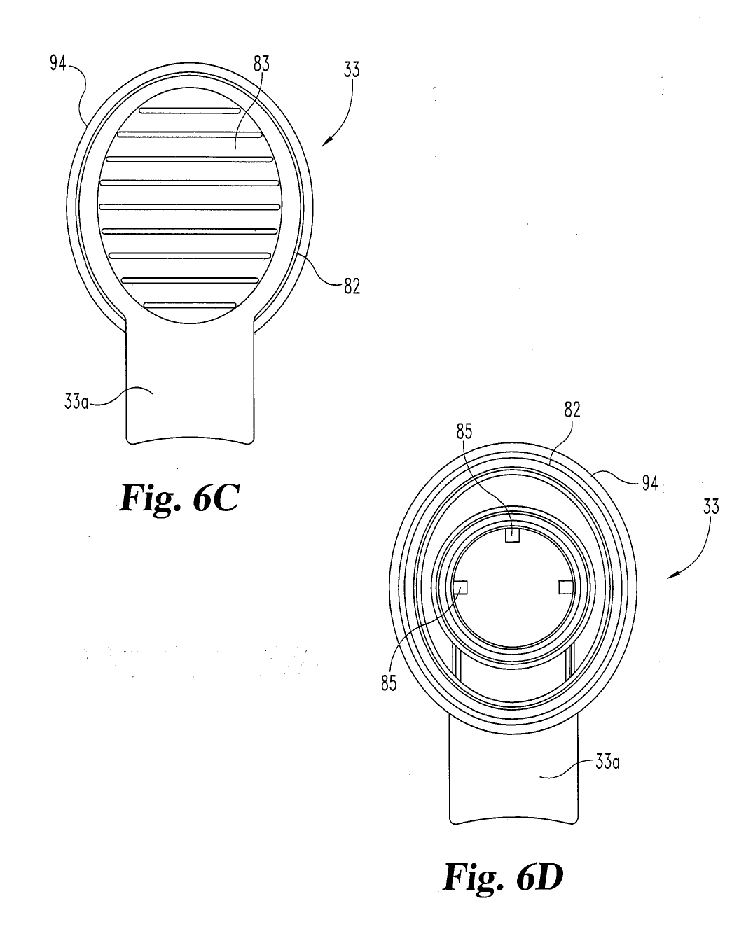

The actuator 33 is further illustrated in FIGS. 6A-6D and includes, in addition to nozzle portion 33a which defines dispensing opening 34, an inner annular wall 81, outer elliptical wall 82, upper panel 83, and lower shelf 84. Actuator 33 is a single piece construction and is preferably molded out of a suitable plastic material, such as polypropylene. The lower shelf 84, in cooperation with a portion of upper panel 83 and the illustrated side portions, creates nozzle portion 33a and defines the size, shape, and location of dispensing opening 34.

The inner wall 81 blends into the upper panel 83 and into the lower shelf 84. The inwardly and axially extending abutment ribs 85 (three total) define a generally horizontal abutment shelf for the foamer housing 45 adjacent the upper mesh screen 47. The lower end 86 of the inner wall 81 receives an upper wall 87 of piston 43. The lower edge 86a of end 86 is constructed and arranged to abut up against radial shelf 101f of the piston 43. The foamer housing body 45a (see FIG. 8A) includes an upper portion 88 with a first larger outside diameter and a lower portion 89 with a smaller outside diameter. The smaller outside diameter portion 89 in cooperation with inner wall 81 defines a generally cylindrical space 90 which is constructed and arranged to receive upper wall 87. The larger outside diameter upper portion 88 of the foamer housing 45 is captured between abutment ribs 85 and the upper edge 87a of upper wall 87 of piston 43.

The inner wall 81 of actuator 33 is generally cylindrical. The outer wall 82 of actuator 33 has an elliptical shape which is constructed and arranged in cooperation with interior opening 24a of collar 24. The lower end 93 of outer wall 82 is formed with an outwardly protruding portion 94 which is preferably of a continuous annular form corresponding to the elliptical shape of outer wall 82. Protruding portion 94 has a bulbous outer surface which contacts the inner surface 52a of the raised actuator lip 52. Dimensionally, the size of the outer surface of protruding portion 94 is larger than the size of the inner surface of the raised actuator lip 52. By creating these two contacting surfaces with this dimensional interference (i.e., an interference fit in the up position), a pre-designed force level is required to break loose the actuator 33 from this interference fit and the temporary “capture” by the collar 24.

As is illustrated in FIG. 3A, the inner wall 51 which includes abutment projections 55 has an innermost, segmented surface 95 defined by the inner surfaces of the abutment projections 55. The inner surface 95a of wall 51 is disposed between adjacent abutment projections 55. Both surfaces 95 and 95a are generally cylindrical, although both are segmented due to the spacing between adjacent abutment projections 55. Inner surface 95 is larger in diameter size than the inside diameter surface 52a of actuator lip 52. Further, the inner surface 95 is larger than the size of the outside diameter surface or extent of the outwardly protruding portion 94 so as to establish a clearance space 97 therebetween after sufficient axial travel of the actuator 33. This means that once portion 94 slides below surface 52a, the dimensional interference between the collar 24 and actuator 33 is eliminated and the air flow clearance space is created between the actuator and the collar. Further, the downward axial movement of the actuator 33 also increases the resisting spring force due to compression of spring 37 by the downward travel of the actuator 33.

It is also envisioned that the outwardly protruding portion 94, in lieu of a continuous annular form, in this embodiment elliptical, could be formed in sections spaced apart around the surface of the outer wall 82. A further design variation is to mold or machine a detent or detents into the inner surface 52a of the actuator lip 52. Such a detent or detents would be sized and shaped to receive protruding portion 94, similar to a ball detent arrangement. A further design variation on this alternative design option is to reverse the male/female forms of the ball detent. This would mean a detent or detents formed in the outer wall 82 of the actuator 33 and a protruding portion (or portions) which would typically have a bulbous shape, formed on the inner surface 52a of the actuator lip 52. Even if detents are not used, the current embodiment which is illustrated could have the roles reversed by forming the bulbous projection on the collar and modifying the shape of the lower end of the outer wall 82 in order to be compatible and provide the desired interference fit.

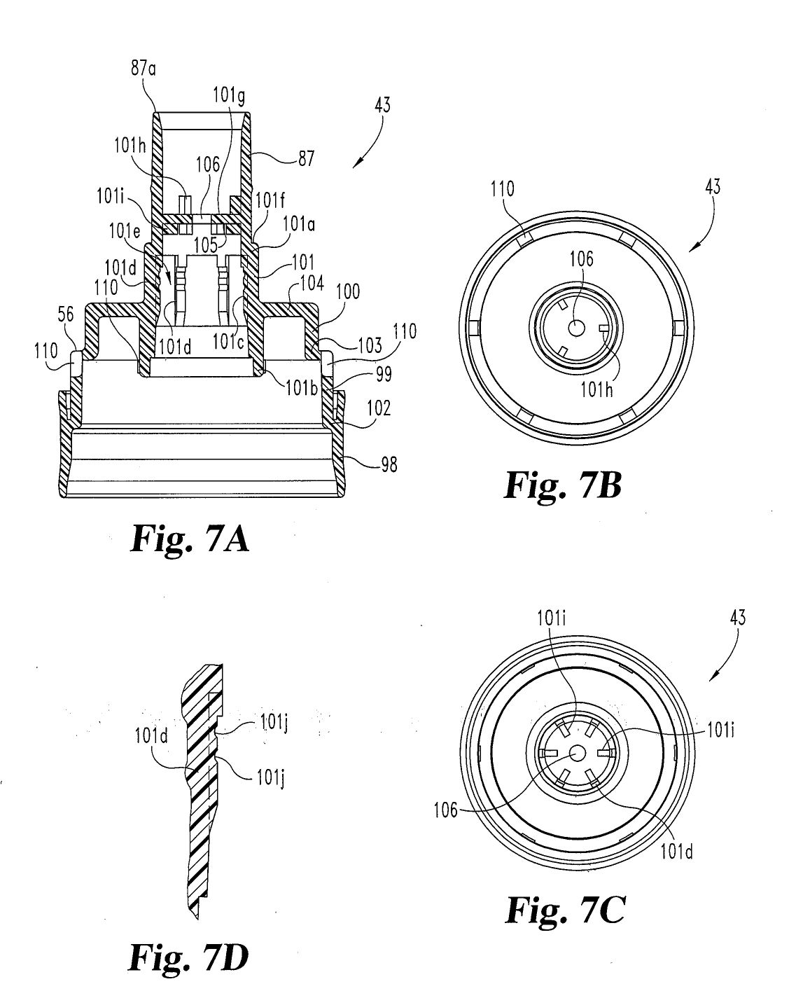

Referring now to FIGS. 7A-7D, the structural details of piston 43 are illustrated further. In addition to the upper annular wall 87, piston 43 includes a sliding seal 98, generally cylindrical walls 99, 100 and 101, generally horizontal annular connecting sections 102, 103 and 104, and shelf 105 which defines central aperture 106. The flows of air and liquid pass through aperture 106 before entering foamer housing 45 via the first mesh screen 46. The sliding seal 98 is constructed and arranged so as to maintain at least the upper and lower edges in sliding and sealing contact against the inside surface of wall 63. The sliding seal 98 also seals over the air vent hole 63a in the body 40 when the actuator is in the “up” position prior to a downward stroke to initiate the production of foam. During the downward stroke, the sliding seal 98 moves downwardly away from hole 63a, allowing air from the atmosphere to enter the container 22 by way of collar 24.

Wall 101 has an upper portion 101a which is a larger outside diameter extension of wall 87 and a lower portion 101b. The interior surface 101c of portion 101a is constructed and arranged with a series of six (6) equally-spaced axial splines 101d with air flow channels 101e being defined therebetween by the axial splines. The enlarged inside diameter at the lower free end of portion 101b is constructed and arranged to receive the radial rib 109 of the plunger 42. The larger diameter of portion 101a relative to the outside diameter of wall 87 creates a relatively narrow radial shelf 101f which is contacted by the lower edge 86a of the inner wall 81 of actuator 33, during manual axial depression of the actuator 33 to initiate the production of foam. The corner junction 56 of wall 99 and connecting section 103 defines a plurality of spaced-apart air vent openings 110. These opening are closed off by a skirt portion of one-way valve 44. A positive pressure within air chamber 30 on the valve 44 skirt during the dispensing stroke seals these air vent openings 110 closed. A sufficient negative pressure within air chamber 30 pulls the one-way valve skirt 44c away from the air vent openings 110, allowing air from the atmosphere to flow into the air chamber 30 by way of the air vent openings 110.

Shelf 101g defines central aperture 106. On the upper surface of shelf 101g there are three abutment ribs 101h which are constructed and arranged to cooperate with the positioning of foamer housing 45. These abutment ribs 101h maintain the desired minimum spacing between shelf 101g and mesh screen 46. On the lower (opposite) surface of shelf 101g there are six abutment ribs 101i. These lower abutment ribs 101i are constructed and arranged to cooperate with the valve pin 39 so as to prevent travel of the valve pin head up against shelf 101g which would effectively close off central aperture 106.

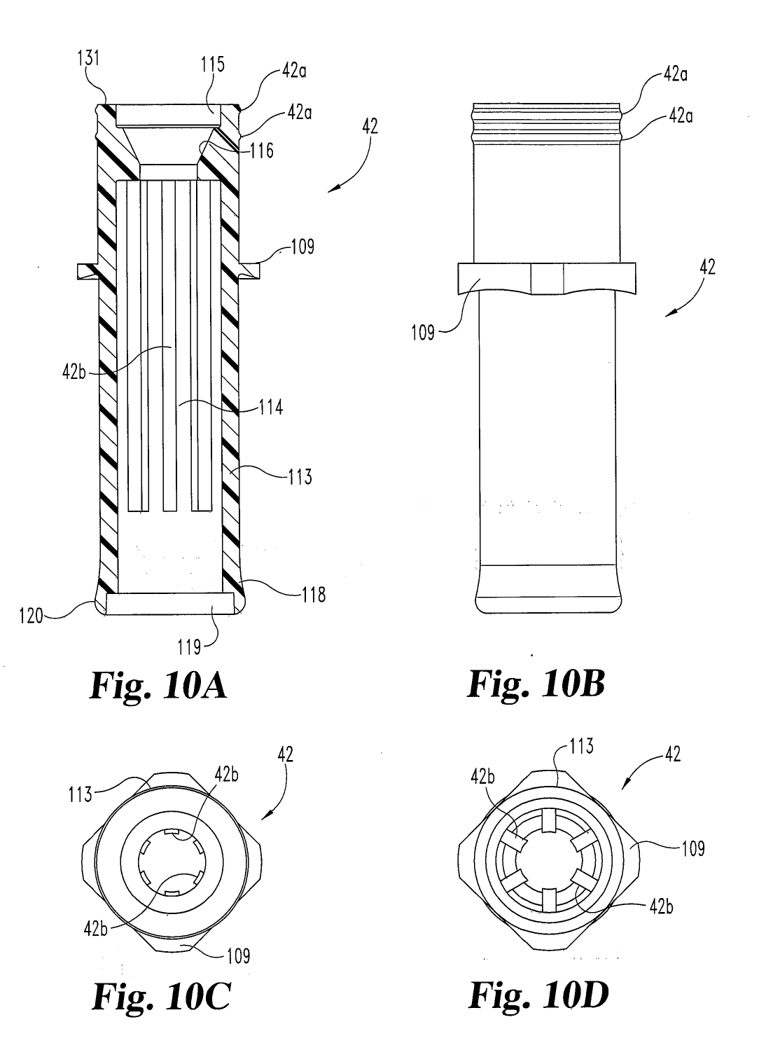

The six axial splines 101d (see FIG. 7D) each have an inner surface contour which includes a pair of axially-spaced detents 101j. These detents cooperate with the raised annular ribs 42a adjacent the upper end of plunger 42 (see FIG. 10A). The rounded outer contour of each rib 42a provides an alignment and assembly feature by the ability to snap into detents 101j. This detent and rib engagement between these two parts properly positions the plunger 42 within the piston 43.

Referring now to FIGS. 8A-8C, the foamer housing 45 is illustrated in greater detail and includes body 45a, standard mesh screen 46 welded over one end and fine mesh screen 47 welded over the opposite end. Housing body 45a has been described as including a larger outside diameter portion 88 and a smaller outside diameter portion 89. The free end of portion 88 includes raised beads to facilitate the welding of mesh screen 47 across the open end of that portion. The free end of portion 89 also includes a raised bead to facilitate the welding of mesh screen 46 across the open end of that portion.

The body 45a is a single piece, molded part, preferably fabricated out of polypropylene with a defined generally cylindrical hollow interior.

The standard mesh of screen 46 has a mesh strand centerline-to-centerline dimension of approximately 0.22 mm and an opening size dimension of approximately 0.165 mm (square). The fine mesh of screen 47 has a centerline-to-centerline dimension of approximately 0.11 mm and an opening size dimension of approximately 0.086 mm (square). Each mesh screen is generally circular with a thickness of approximately 0.10 mm. The material options include nylon, HDPE, polypropylene and polyester and the preferred material is nylon.

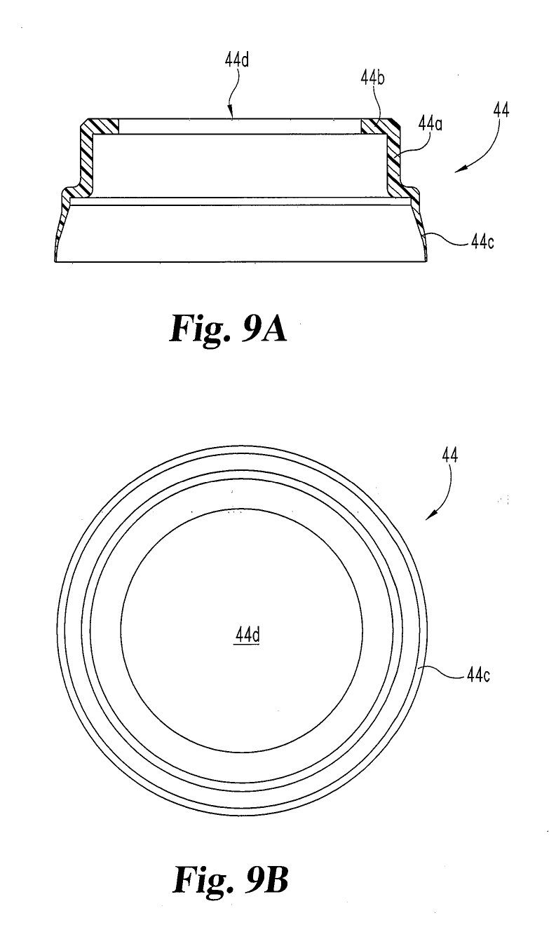

Referring now to FIGS. 9A-9B, the one-way valve 44 is illustrated in greater detail. One-way valve 44 is a single piece, molded component which is preferably fabricated out of a LDPE or LD copolymer. Valve 44 includes a body 44a, upper panel 44b, and flexible, tapered skirt 44c. Panel 44b defines central opening 44d. The positioning of valve 44 relative to piston 43 is illustrated in FIGS. 1 and 2. Skirt 44c is positioned beyond air vent opening 110 and controls the flow of air through the air vent openings, depending on the pressure level (positive or negative) which is present in the air chamber 30.

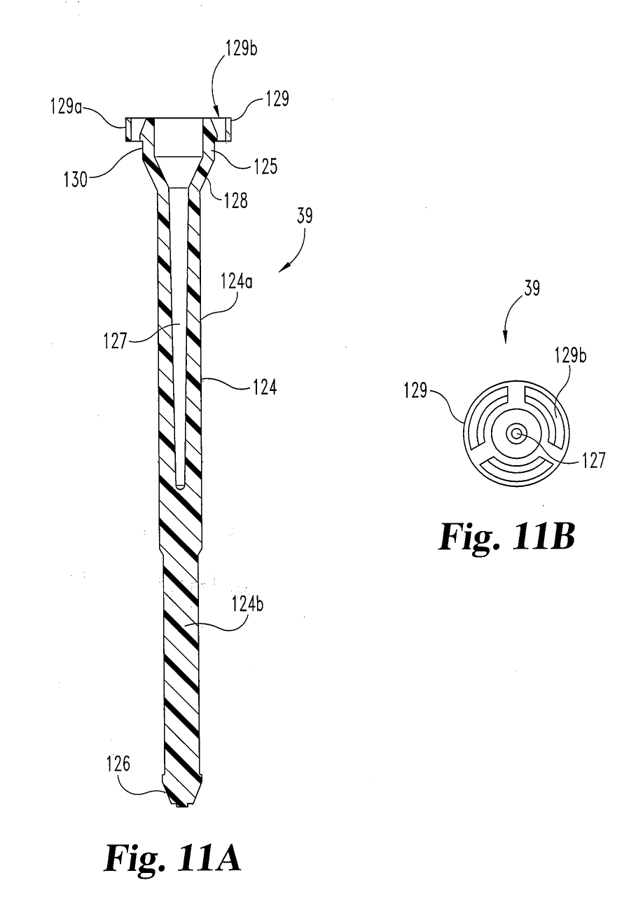

Referring now to FIGS. 10A-10D, plunger 42 is illustrated in greater detail. Plunger 42 is a single piece, molded plastic component which is preferably fabricated out of LDPE material. Plunger 42 has a generally cylindrical body 113 with generally “square” radial rib 109 positioned and arranged as illustrated. The interior opening 114 which is defined by body 113 includes a combination counterbore 115 and frustoconical portion 116 which function as a valve seat for the head 125 of valve pin 39 (see FIGS. 2 and 11A). The lower end 118 is counterbored at 119 and constructed and arranged in order to capture the upper end of spring 37. The slightly rounded outer edge 120 of lower end 118 has an outside diameter size which causes it to abut and slide against the inside surface of the intermediate wall 64 of body 40. The interior opening 114 is constructed and arranged for the series of six axially-extending ribs 42b which define a smaller inside diameter space for the receipt of valve pin 39. The clearance spaces between adjacent ribs 42b provide passageways for the flow of liquid.

Referring now to FIGS. 11A-11B, the valve pin 39 is illustrated in greater detail. Valve pin 39 is a single piece, molded plastic component which includes an elongated body 124, a head 125, and a lower tip 126. The body 124 is constructed and arranged into two primary sections, a larger outside diameter section 124a and a smaller outside diameter section 124b. Section 124a has an open interior 127 which extends up through head 125 for weight reduction. Since valve pin 39 is lifted by the force of the liquid flow up against the underside surface 128 of head 125, the weight of valve pin 39 is a consideration and the functional requirements for body 124 permit weight reduction on the interior 127 in the manner illustrated.

The shape and enlargement of tip 126 relative to section 124b allows a retained snap-fit into the top portion of spring clip 38. The head 125 is constructed and arranged with lower frustoconical portion 128, a flange 129, and a generally cylindrical wall 130 connecting portion 128 with flange 129. Frustoconical portion 128 is sized and shaped to fit generally flush against frustoconical surface 116 of the plunger 42 when the valve pin 39 is in its down and seated position prior to initiation of the foam production process. The spring is constructed and arranged so as to place a modest preload on plunger 42 upwardly against head 125 of valve pin 39. The lower end of spring 37 pushes against flange 137 of spring clip 38. This spring force in turn draws the upper end of spring clip 38 against tip 126. The upper end of spring 37 pushes up on plunger 42 which pushes up on valve pin 39 and thus the spring preload. As the actuator 33 is depressed, the preload is released, allowing the valve pin 39 to essentially float with plunger 42. Without the spring preload, the flow of liquid which is used to lift or raise valve pin head 125 off of the valve seat is able to create a suitable flow path for that liquid. Since the spring preload has been released, the force due to liquid flow only has to exceed the weight of the valve pin 39.

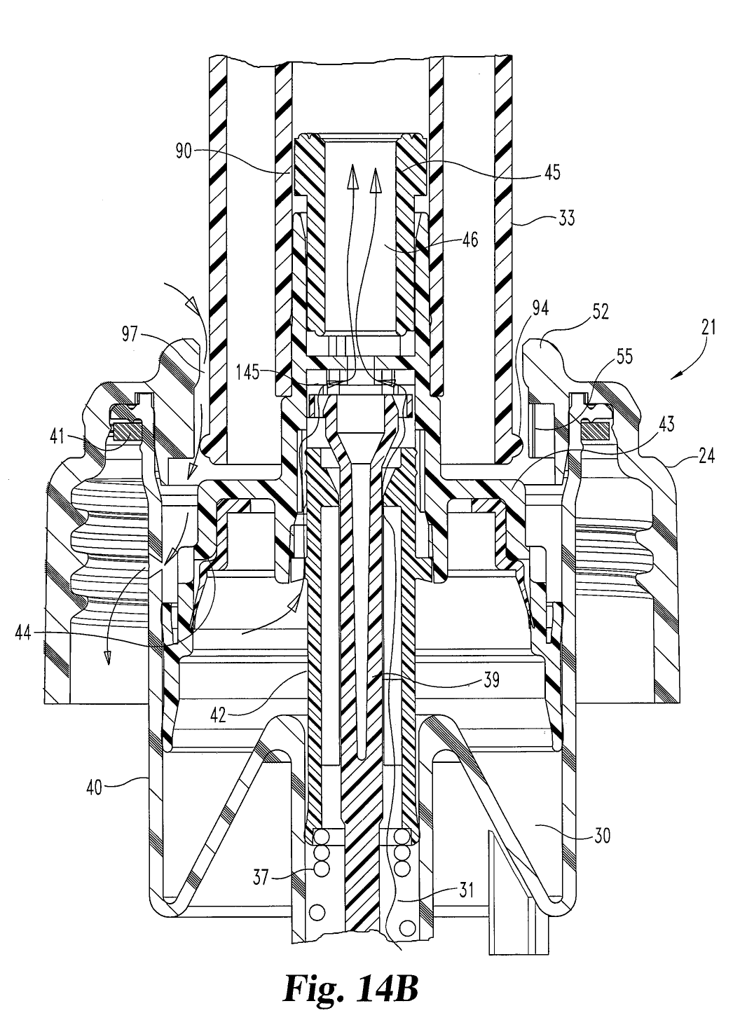

Flange 129 has a continuous outer annular surface 129a which is generally cylindrical without any radial openings therethrough. Radially inwardly of surface 129a are axial flow openings 129b which are defined by the construction and arrangement of flange 129. The lower surface of flange 129 is constructed and arranged to seat on the upper surface 131 of plunger 42 concurrently with portion 128 seating on surface 116. In this seated position prior to the depression of actuator 33, the upper portion of each spline 101d, which extends above the upper surface 131 of plunger 42, is closed or blocked off by the outer annular surface 129a, (see FIG. 14A). When the head 125 is raised off of surface 131, an air passageway is created. The flow of air and liquid are permitted through flow openings 129b once the valve pin head 125 has been raised or lifted off of surface 116 (for liquid flow) and once flange 129 is axially moved in an upward direction and moved out of contact with surface 131. The liquid and air flows are able to combine in space 145 and then subsequently flow through central aperture 106 and from there flow through mesh screen 46, (see FIG. 14B).

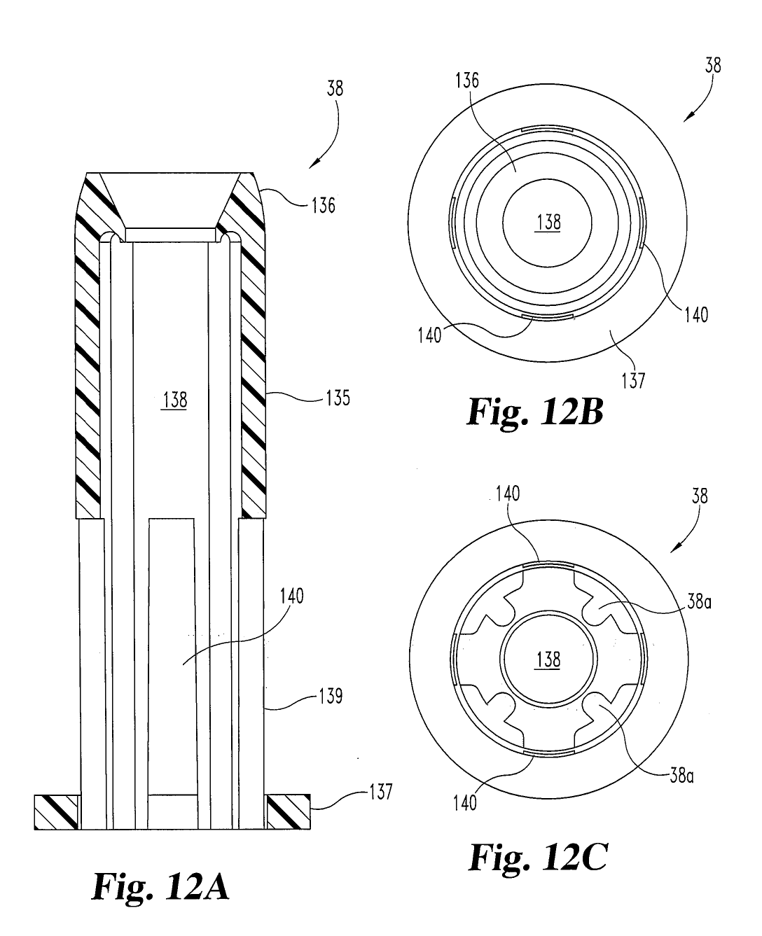

Referring now to FIGS. 12A-12C, the spring clip 38 is illustrated in greater detail. Spring clip 38 is a single piece, molded plastic component which includes a generally cylindrical body 135, a slightly rounded top portion 136 which is countersunk into its upper end, and a radial flange 137 at the lower end. The body 135 defines a hollow interior 138 and the lower portion 139 of the body defines a plurality (four in the selected embodiment) of spaced-apart, axially-extending open slots 140. On the interior are four axially-extending ribs 38a which provide reinforcement to the lower portion wall 139 which is opened by the creation of slots 140.

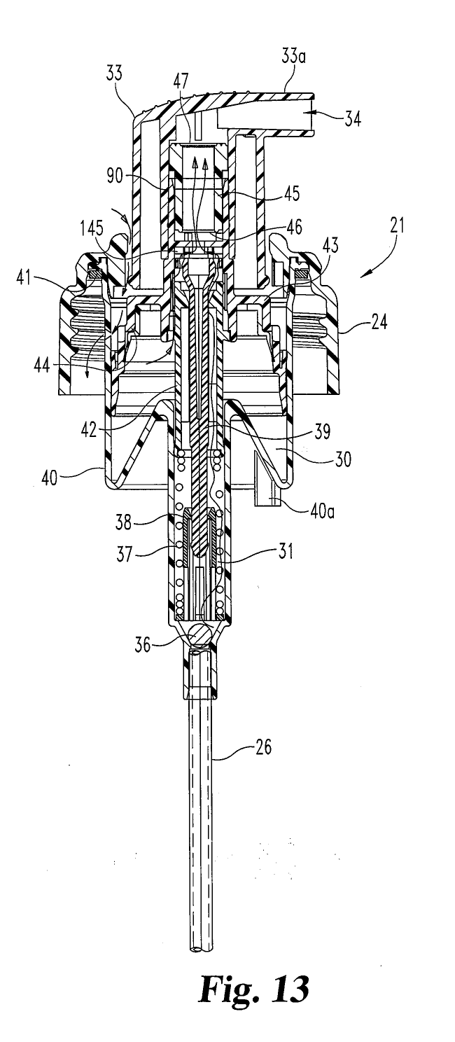

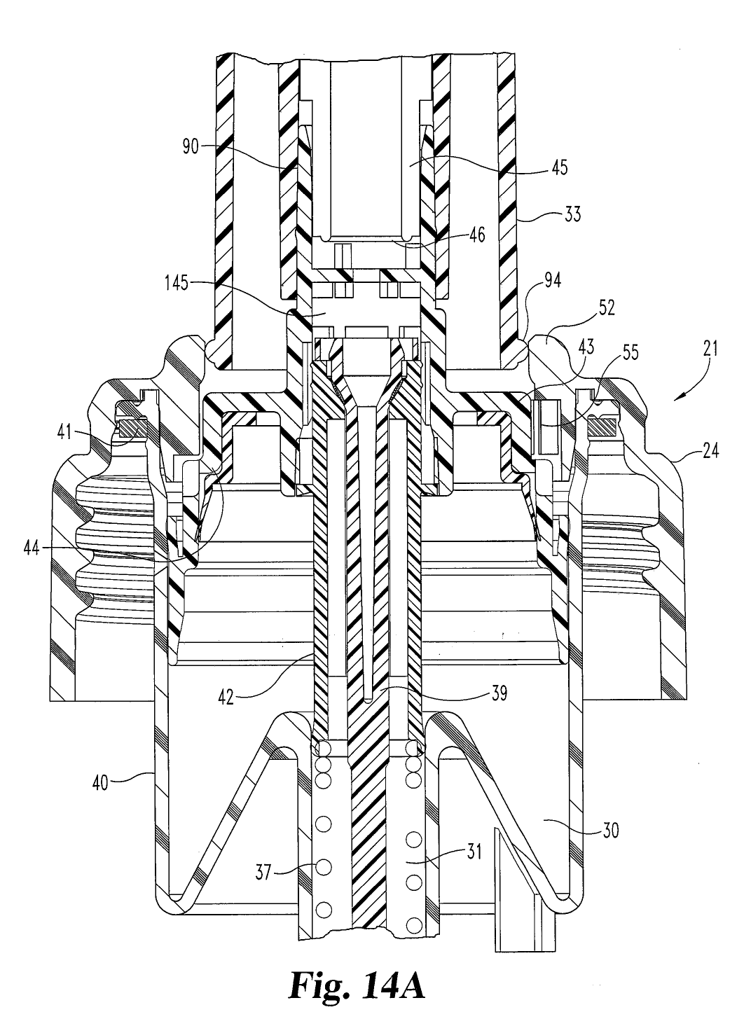

The interior of top portion 136 is constructed and arranged to receive tip 126 of valve pin 39. The tapered shape of tip 126 enables an easy insertion and resulting snap-fit which allows the shaping of the interior of top portion 136 to capture and retain tip 126 while still permitting relative axial movement between section 124b of valve pin 39 and the top portion 136 of spring clip 38, see FIG. 13. The radial flange 137 is constructed and arranged to seat against shelf 144 between body 40 portions 64 and 65 and to receive in abutment the lower end of compression spring 37.

The assembly of foam dispenser 20 is accomplished in sequential stages using subassemblies. One of the subassemblies is foamer housing 45 comprised of the two mesh screens 46 and 47 which are welded to the housing body 45a. Another subassembly (the valve pin subassembly) includes spring 37, spring clip 38, valve pin 39, and plunger 42. A portion of spring 37 is received within plunger 42 and a portion of spring 37 is received by spring clip 38. The valve pin 39 seats within plunger 42 with lower tip 126 received by spring clip 38.

With these first two subassemblies completed, the next stage includes assembly of the foamer housing into piston 43 and the assembly of the one-way valve 44 into piston 43. This piston subassembly receives the valve pin subassembly and these two subassemblies are received by body 40. The one-way valve 44 fits up into piston 43 with an interference fit which is continuous in annular form and seals up into the interior corner of piston 43.

One preliminary step prior to body 40 receiving the two subassemblies is to place ball 36 on the valve seat 67. Another preliminary step in terms of the assembly equipment which is preferably used is to located the body in the desired location and with its desired orientation. Projection 40a is sized and shaped to fit within a receiving pocket or recess in the automated assembly equipment in order to achieve the desired location and the desired orientation. The subassembly which is created after this last stage is assembled into collar 24 and actuator 33 is snapped into collar 24. This assembly step seats the foam housing 45 up into the interior of the actuator 33, as previously explained.

The final step prior to threaded connection of the pump assembly 21 to the container 22 is to insert the upper end of the dip tube 26 into the body 40 (interference fit). The insertion of the dip tube completes the pump assembly 21. Since it is necessary to add the desired liquid into the container 22, this step is typically performed by a filler prior to the step of connecting the pump assembly 21 to the container. A further required step is to apply the overcap 23. The overcap 23 can be snapped onto the collar prior to connection of the pump assembly 21 to the container 22. Since each pump assembly 21 is not uniquely matched with a corresponding container 22, at least not prior to the addition of liquid, the pump assemblies 21 are able to be shipped to the filler, either with the containers, when coming from the same source of supply, or separately, when coming from different sources of supply.

In use, the status of foam dispenser 20 begins generally as illustrated in FIG. 1 with the foam dispenser 20 in an upright orientation seated on a generally horizontal surface. In this starting orientation, a volume of liquid is already packaged into container 22 and the protective overcap 23 has been snapped onto the collar 24. When it is desired to produce and dispense some amount of foam, based on the composition of the starting liquid, the overcap 23 is removed and the actuator 33 is pushed, either by the user or someone on behalf of the user, in an axially downward direction. The force level exerted on the upper panel 83 in a downward direction must initially overcome the resisting interference force due to the contact interference between the actuator and the collar. This interference fit and the resisting force remain until the outwardly protruding portion 94 travels to a point so as to no longer contact the inner surface 52a of actuator lip 52. Before reaching this clearance point, the lower edge 86a of the inner wall 81 abuts up against the shoulder 101f of upper portion 101a and initiates axial travel of piston 43 and in turn the downward axial travel of plunger 42. The valve pin 39 follows the downward axial travel of plunger 42. This initial axial travel of plunger 42 begins to compress spring 37, creating further resistance to the downward axial travel of the actuator 33. Assuming that the foam dispenser 20 is not pre-charged with a volume of liquid already pumped into the liquid chamber 31, an initializing or priming first stroke is required the first time the foam dispenser 20 is to be used before foam is able to be dispensed.

After this initial priming stroke, the subsequent downward axial travel of piston 43 and plunger 42 (the second overall stroke) reduces the open volume size of the air chamber 30 and the open volume size of the liquid chamber 31, respectively. The designed volume sizes of air chamber 30 and liquid chamber 31 have a size ratio of approximately 9.5:1 which essentially governs the air-to-liquid ratio by volume. The downward axial travel of piston 43 and plunger 42 reduces the air chamber 30 and liquid chamber 31 volumes proportionately so as to maintain approximately this same ratio. The reduction in volume means an increase in pressure. In the air chamber 30, this internal pressure seals the tapered skirt 44c of the one-way valve 44 against the inside surface of the body, preventing any noticeable escape of air through or across this interface. The internal pressure forces the volume of air in the air chamber 30 to seek an exit passageway or exit aperture.

The downward axial movement of plunger 42 pressurizes the liquid chamber 31 and forces the pre-charge of liquid contained therein, due to the initial charging stroke, to seek a flow opening or passageway in order to exit from the liquid chamber 31. As would be understood, the pressurizing of the liquid chamber pushes ball (valve) 36 against the frustoconical seat 67 formed by body 40. Structurally, a liquid passageway is provided through the interior defined by intermediate wall 64 of body 40. This upward flow of liquid passes through spring 37 and through the interior of plunger 42. This liquid flow passageway is defined by the inside diameter of plunger 42 and by the outside diameter of elongated body 124 of valve pin 39. When this liquid flow reaches the head 125 of valve pin 39 (as seated on plunger 42), the liquid pressure acts on the lower portion 128 of head 125. When the liquid pressure force, due to the flow of liquid, exceeds the weight of the valve pin 39, the valve pin head 125 is raised or lifted off of the frustoconical seat 116. This movement opens a passageway around head 125, allowing a flow of liquid to enter space 145 (see FIGS. 2 and 14b).

When the valve pin head 125 moves in an axially upward direction off of frustoconical surface 116, the valve head flange 129 moves out of its blocking position against splines 101d. This movement creates an air flow passageway for the air under pressure within the air chamber 30 to escape. It is the flow of liquid which lifts or raises the valve pin head 125 and this action creates not only a liquid flow passageway around the valve head 125, but the lifting action caused by the flow of liquid also creates an air flow passageway through the splines 101d and through the valve head flow openings 129b into space 145. The single action of liquid flow at a sufficient “lifting” pressure or force, in cooperation with the valve pin head 125, creates both a liquid flow passageway and then an air flow passageway (see FIGS. 2 and 14A and 14B). Viewed in a slightly different manner, the lifting or raising of the valve pin head 125 results in creating both the liquid flow passageway into space 145 and the air flow passageway into space 145.

The force of liquid flowing up against the valve pin head 125 causes the valve pin head 125 to lift off of frustoconical surface 116. Accordingly, there is some amount or volume of liquid which actually reaches space 145 before the leading edge of the air flowing past the splines 101d is able to reach space 145. In turn, this means that there is a flow of air into and through the initial volume of liquid before this air-liquid mixture flows through central aperture 106 on its way to foamer housing 45. This initial flow of air into the initial volume of liquid in space 145 functions similar to the mixing and aeration achieved by a mesh screen. The timing of the initial liquid flow and the initial air flow subsequent thereto which move into space 145 causes the combination of flows to functionally behave to some extent or degree similar to a mesh screen without the cost of providing what would be a third mesh screen. The use herein of the term “mixing” is intended to refer to aeration of air and liquid whereby air bubbles are created and some portion of these are coated with a thin film of the corresponding liquid.

The production of foam involves essentially the creation of small air bubbles which are coated with a thin layer of the liquid, allowing the liquid surface tension to maintain the liquid coating, even as larger bubbles are made smaller as that mixture passes through a subsequent mesh screen. Starting with what would preferably be a planar stream of liquid, the air is forced through the liquid so that the aeration into smaller bubbles is accomplished in the presence of the liquid, which in turn coats a majority of those bubbles as the bubbles are formed. As larger bubbles are split or aerated into smaller bubbles, the liquid continues to coat the outer surface and cling to that outer surface due to the surface tension of the liquid.

The air-to-liquid ratio (by volume) is controlled principally by the volumes of the air chamber 30 and the liquid chamber 31. To a lesser degree, the flow openings or passageways are a factor. It is considered that a high quality foam will be produced with an air-to-liquid ratio (by volume) in the range of from approximately 9.5:1 up to approximately 10.0:1 or perhaps higher.

With a continuation of the downward stroke of actuator 33, the air and liquid mixture is forced from and through space 145 into foamer housing 45. The travel of the air and liquid mixture into and through housing 45 begins (i.e., enters) with the standard (coarser) mesh screen 46 and then exits through the finer mesh screen 47. The exiting foam is dispensed out through nozzle portion 33a and specifically out dispensing opening 34. These three foam production stages progressively create smaller and smaller bubbles and ultimately achieve what is regarded as quality foam.

Another factor which has a bearing on the quality of foam is the speed of the air-liquid mixture as it is pushed through the mesh screens 46 and 47. Slow pumping of the liquid and air mixture is likely to flood the first mesh screen 46 and the result is a poorer quality foam or no foam.

As described, the interference fit between the collar 24 and actuator 33 causes a greater actuation force to be exerted over what would otherwise be required to actually depress the actuator, assuming no interference fit. Once the outwardly protruding portion 94 of the actuator 33 travels downwardly passed the interference surface of actuator lip 52, the actuator 33 to some extent breaks free and experiences an acceleration which helps to generate the desired speed for the movement of the piston 43 and thus the desired speed for the flows of liquid and air. This interference between the collar 24 and actuator 33 and the resulting acceleration can be further described by thinking of what happens when a refrigerator door is opened. Once the magnetic force is overcome, the door experiences a brief period of acceleration due to the added force which has been applied and is now higher than needed to move the door. While this higher force was required initially to overcome the magnetic force, once that magnetic force or attraction is broken, the door breaks free and there is a brief period of acceleration. The flow speed of the liquid and air constituents is also influenced to some degree by the size of the flow openings and passageways.

As the downward stroke of the actuator continues, the compression force on spring 37 increases, thereby storing kinetic spring energy for the spring return stroke which will move the actuator 33 and the related components back to their upper starting position as illustrated in FIG. 2. When the user of foam dispenser 20 removes the force or pressure on actuator 33, spring 37 tries to extend itself back to its starting or static position as is illustrated in FIG. 2. The upward travel of plunger 42, as acted on by spring 37, engages the valve pin head 125 and pushes up on piston 43. This upward travel creates a negative pressure in the liquid chamber 31 and pulls up ball 36 off of its valve seat 67. This action creates a liquid flow path for a replacement volume of liquid to be drawn out of the container and delivered into the liquid chamber 31 as the next charge of liquid for the next foam dispensing cycle. As the next charge of replacement liquid is suctioned out of the container 22, the negative head pressure is equalized by the flow of air through the clearance space created between the actuator and the collar and through hole 63a (see FIG. 14B).

The negative pressure in the air chamber due to the upward movement of piston 43 pulls tapered skirt 44c away from the inside surface of wall 99 and thereby uncovers the air vent openings 110. Thereafter, replacement air is able to enter the air chamber 30 by way of the separation gap or space 97 between the collar 24 and the actuator 33 (see FIG. 14B).

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A foam dispenser for dispensing a liquid with a foam consistency, said foam dispenser comprising:
a container constructed and arranged to hold a volume of said liquid; and
a pump assembly connected to said container, said pump assembly comprising:
an actuator defining a foam-dispensing outlet;
a collar constructed and arranged to connect to a portion of said container, said collar receiving said actuator with an interference fit;
a body defining an air chamber and a liquid chamber;
a foamer housing received by said actuator and including a mesh screen;
an air piston received by said air chamber;
a plunger extending through a portion of said air chamber into said liquid chamber;
a movable valve pin received by said plunger;
an air valve received by said piston and being constructed and arranged to control the flow of replacement air into said air chamber; and
liquid flow control means received by said body and cooperating with said volume of liquid for controlling the flow of replacement liquid into said liquid chamber.

2. The foam dispenser of claim 1 wherein said interference fit is between an upper lip portion of said collar and a lower end projection of said actuator.

3. The foam dispenser of claim 2 wherein said upper lip portion defining an axially lower portion of increased inside diameter size which defines a clearance space with said lower end projection.

4. The foam dispenser of claim 3 wherein said body includes an air vent hole and said clearance space being in air flow communication with said air vent hole.

5. The foam dispenser of claim 4 wherein said piston defines an air vent opening, said clearance space being in air flow communication with said air vent opening.

6. The foam dispenser of claim 1 wherein said actuator is constructed and arranged to engage said piston during downward axial travel of said actuator.

7. The foam dispenser of claim 6 wherein said plunger is acted on by said piston to impart downward axial travel to said plunger.

8. The foam dispenser of claim 7 wherein said piston travel reduces the open volume size of the air chamber and said plunger travel reduces the open volume size of the liquid chamber.

9. The foam dispenser of claim 8 wherein said air chamber has a starting volume size which is approximately 9.5 times the starting volume size of said liquid chamber.

10. The foam dispenser of claim 9 wherein the volume size reductions due to the downward axial travel of the piston and of the plunger reduce the respective volume sizes proportionately.

11. The foam dispenser of claim 1 wherein said plunger defines a valve seat and said valve pin includes a head which is constructed and arranged to engage said valve seat.

12. The foam dispenser of claim 11 wherein said valve pin head being constructed and arranged to be movable out of said engagement when acted upon by the force of a liquid flow so as to permit liquid flow into said foamer housing.

13. The foam dispenser of claim 12 wherein said valve pin head is constructed and arranged to close off an air flow passageway between said valve pin head and said piston when said valve pin is in said engagement with said valve seat.

14. The foam dispenser of claim 13 wherein lifting said valve pin head off of said valve seat due to the force of a liquid flow also opens said air flow passageway for permitting air flow into said foamer housing.

15. The foam dispenser of claim 14 wherein said valve pin head, said piston, and said plunger are cooperatively constructed and arranged to permit a pre-mix of liquid and air prior to entering the foamer housing, with the air flowing into the liquid.

16. The foam dispenser of claim 1 wherein said actuator including an outer wall with an elliptical shape.

17. The foam dispenser of claim 16 wherein said collar defining an opening which receives said outer wall with said interference fit, said opening having a cooperating elliptical shape.

18. A foam dispenser for dispensing a liquid with a foam consistency, said foam dispenser comprising:
a container constructed and arranged to hold a volume of said liquid; and
a pump assembly connected to said container, said pump assembly comprising:
an actuator defining a foam-dispensing outlet;
a collar constructed and arranged to connect to a portion of said container, said collar receiving said actuator;
a body defining an air chamber and a liquid chamber;
a foamer housing received by said actuator and including a mesh screen;
an air piston received by said air chamber;
a plunger extending through a portion of said air chamber into said liquid chamber;
a movable valve pin received by said plunger;
an air valve received by said piston and being constructed and arranged to control the flow of replacement air into said air chamber;
liquid flow control means received by said body and cooperating with said volume of liquid for controlling the flow of replacement liquid into said liquid chamber; and
wherein said valve pin is movable relative to said plunger between a seated position and a raised position in response to a liquid flow force applied to a portion of said valve pin, said raised position defining in cooperation with said plunger a liquid flow passageway and defining in cooperation with said piston an air flow passageway.

19. The foam dispenser of claim 18 wherein said plunger defines a valve seat and said valve pin includes a head which is received by said valve seat when said valve pin is in said seated position.

20. The foam dispenser of claim 19 wherein said liquid flow which generates said force for moving said valve pin head to said raised position travels from said liquid chamber upwardly through said plunger.

21. The foam dispenser of claim 20 wherein said valve pin head includes a flange having an outer surface and inwardly of said outer surface a flow opening constructed and arranged for the flow of air therethrough before entering said foamer housing.

22. The foam dispenser of claim 18 wherein said actuator is constructed and arranged to engage said piston during downward axial travel of said actuator.

23. The foam dispenser of claim 22 wherein said plunger is acted on by said piston to impart downward axial travel to said plunger.

24. The foam dispenser of claim 23 wherein said piston travel reduces the open volume size of the air chamber and said plunger travel reduces the open volume size of the liquid chamber.

25. The foam dispenser of claim 24 wherein said air chamber has a starting volume size which is approximately 9.5 times the starting volume size of said liquid chamber.

26. The foam dispenser of claim 25 wherein the volume size reductions due to the downward axial travel of the piston and of the plunger reduce the respective volume sizes proportionately.

27. The foam dispenser of claim 18 wherein said actuator including an outer wall with an elliptical shape.

28. The foam dispenser of claim 27 wherein said collar defining an opening which receives said outer wall with said interference fit, said opening having a cooperating elliptical shape.

29. The foam dispenser of claim 28 wherein said collar receiving said actuator with an interference fit.
